(19) United States
(12) Patent Application Publication
(10) Pub. No.: US 2007/0269149 A1
(43) Pub. Date: Nov. 22, 2007

(54) Hydrodynamic bearing having additional reservoir

(75) Inventor: Tae Hyeong Lim, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/723,713

(22) Filed: Mar. 21, 2007

(30) Foreign Application Priority Data
Apr. 20, 2006 (KR) 10-2006-0035824

(51) Int. Cl. F16C 32/06

(52) U.S. Cl. 384/100

(57) ABSTRACT

Disclosed herein is a hydrodynamic bearing having an additional fluid reservoir, which has improved ability to efficiently seal fluid (lubricant), which generates dynamic pressure. The hydrodynamic bearing has an annular fluid storage space coupled to the lower portion of a fluid reservoir, in addition to the existing fluid reservoir formed in the upper portion of a hydrodynamic space. In particular, the fluid storage space has a tapered cross-section which is increased in the direction from the end where the fluid storage space is coupled to the fluid reservoir to the opposite end (the portion where a through hole is formed), thus serving as an additional fluid reservoir for sealing fluid and supplying the fluid to the hydrodynamic space. Further, unlike the prior art, where the surface of the fluid is controlled using only the existing fluid reservoir, having a relatively narrow area, the surface of the fluid can be controlled using both a wider fluid storage space and the existing fluid reservoir, thus affording convenience when the hydrodynamic bearing is used.

### CROSS REFERENCE TO RELATED APPLICATION(S)

This application claims the benefit of Korean Patent Application No. 10-2006-0035824, filed on Apr. 20, 2006, entitled “Hydrodynamic bearing with an additional reservoir”, which is hereby incorporated by reference in its entirety into this application.

### BACKGROUND OF THE INVENTION

1. Field of the Invention

The present invention relates generally to a hydrodynamic bearing and, more particularly, to a hydrodynamic bearing having an additional fluid reservoir, which has improved ability to efficiently seal fluid (lubricant), which generates dynamic pressure.

2. Description of the Related Art

The sealing of fluid (lubricant) is one of the most important characteristics required for a hydrodynamic bearing. Thus, extensive technologies relating to the control of fluid in the hydrodynamic bearing, including the sealing characteristics of the fluid injected into the hydrodynamic bearing, the injection of the fluid, and the control of a fluid surface, are required. However, only some of the technologies relating to fluid control in the hydrodynamic bearing are known.

For example, a fluid sealing structure for hydrodynamic bearings is disclosed in Japanese Patent Laid-Open Publication No. Hei8-210364, which was filed by Sankyo Seiki Mfg. Co., Ltd. of Japan, and was published on Aug. 20, 1996, and Japanese Patent Laid-Open Publication No. 2004-36892 which was filed by Minebea Co., Ltd. of Japan and was published on Feb. 5, 2004. Hereinafter, the fluid sealing structure will be described in brief with reference to the accompanying drawings.

As shown in FIG. 1, a conventional sealing structure (Prior Art 1) includes a rotary member 10 and a stationary member 20 fastened to the rotary member 10, with a hydrodynamic space 30 defined between the rotary member 10 and the stationary member 20. A gap variation part A is formed at an open end of the hydrodynamic space 30 and is inclined at a predetermined angle α. FIG. 1 shows only part of the sealing structure around a central axis C.

According to the prior art, fluid F is injected into the hydrodynamic space 30 between the rotary member 10 and the stationary member 20, and the surface Fs of the fluid is maintained at the gap variation part A, thus allowing the fluid to be stably retained in the hydrodynamic bearing. The conventional sealing structure is problematic in that the volume of the gap variation part A is relatively small, so that the fluid is evaporated or leaks out from the hydrodynamic bearing after the hydrodynamic bearing having such a sealing structure has been used for a lengthy period of time, thus resulting in the lack of fluid in the hydrodynamic bearing.

Further, as shown in FIG. 2, another conventional sealing structure (Prior Art 2) includes a rotary member 110 which is provided with a flange 112, a stationary member 120 which surrounds the rotary member 110, a housing 130 which surrounds the stationary member 120 and is provided with a cover 132 to cover the upper surface of the stationary member 120, a support part 140 which is provided in the lower portion of the housing 130 and supports the rotary member 110, and a spacer 150 which is interposed between a cover 132 of the housing 130 and the upper surface of the stationary member 120.

A very narrow hydrodynamic space 160 is defined between the rotary member 120 and the corresponding parts, and between the flange 112 and the corresponding parts. Fluid, such as a lubricant, is injected into the hydrodynamic space 160, thus supporting the rotary member 110 in a non-contact manner by dynamic pressure.

In the conventional sealing structure, fluid is injected through a fluid reservoir 162 which is defined between the cover 132 and the spacer 150. The injected fluid flows through an opening 152 formed at a predetermined position in the spacer 150, and through a gap between the spacer 150 and the stationary member 120, into the hydrodynamic space 160. The fluid injected into the hydrodynamic space 160 supports the rotary motion of the rotary member 110 in a non-contact manner through dynamic pressure.

The conventional sealing structure is problematic in that the fluid is injected through the relatively narrow fluid reservoir 162 defined between the cover 132 and the spacer 150, so that it is difficult to inject the fluid. Further, since it is difficult for a worker to confirm the amount of fluid that is injected because of the cover 132, it is difficult to control the injection of the fluid and a fluid surface.

As such, the conventional sealing structure is problematic in that the volume of the fluid reservoir 162 is relatively small, so that the fluid in the hydrodynamic bearing is evaporated or discharged to the outside after the hydrodynamic bearing has been used for a lengthy period of time, thus resulting in a lack of fluid in the hydrodynamic bearing.

### SUMMARY OF THE INVENTION

Accordingly, the present invention has been made keeping in mind the above problems occurring in the prior art, and an object of the present invention is to provide a hydrodynamic bearing, which is capable of stably supplying a proper amount of fluid to hydrodynamic space, and easily controlling the surface of fluid injected into the hydrodynamic space.

In order to accomplish the above object, the present invention provides a hydrodynamic bearing including a rotary member which rotates about a central axis, an annular stationary member which is fastened to the rotary member, with a very narrow gap provided in a radial direction of the rotary member, thus defining hydrodynamic space between the rotary member and the stationary member, a cover which is fastened to an upper surface of the stationary member and defines a fluid reservoir between the rotary member and the cover, the fluid reservoir coupled to the hydrodynamic space and having a tapered cross-section, and a support member which is fastened to a lower end of the stationary member and supports a lower portion of the rotary member. In this case, the rotary member is supported in a non-contact manner by hydrodynamic action of fluid in the hydrodynamic space, and an annular fluid storage space is further formed between the cover and the upper surface of the stationary member, the fluid storage space being coupled at a predetermined position to a lower portion of the tapered fluid reservoir, so that the fluid storage space serves as an additional fluid reservoir.

According to an aspect of the invention, a portion of the fluid storage space opposite a portion where the fluid storage space is coupled to the fluid reservoir communicates with an exterior through a hole which is formed through the cover, and pressure acting on a fluid surface in the fluid storage space is equal to pressure acting on a fluid surface in the fluid reservoir.

The fluid surface formed in the fluid reservoir is an annular fluid surface formed in the radial direction of the rotary member.

The fluid storage space is formed to have a cross-section which gradually increases in a direction from a portion where the fluid storage space is coupled to the fluid reservoir to a portion of the fluid storage space adjacent to the hole passing through the cover.

An annular groove is formed in a lower portion of the cover corresponding to the upper surface of the stationary member, thus defining the fluid storage space.

A coupling channel is formed in the cover to extend from a position in the annular groove coupled to the fluid reservoir, the fluid storage space being coupled to the fluid reservoir via the coupling channel.

The rotary member has on a lower portion thereof a flange protruding in the radial direction of the rotary member. The hydrodynamic bearing further includes an annular housing surrounding the stationary member. The cover comprises an annular protruding part which is provided on an upper portion of the housing, formed to be higher than the upper surface of the stationary member, and protrudes toward the rotary member.

A very narrow gap is provided between the lower portion of the stationary member and the flange, thus forming additional hydrodynamic space between the stationary member and the flange, and the support member is fastened to a lower end of the housing.

Further, in order to accomplish the above object, the present invention provides a hydrodynamic bearing including a rotary member which rotates about a central axis, an annular stationary member which is fastened to the rotary member, with a very narrow gap provided in a radial direction of the rotary member, thus defining a hydrodynamic space between the rotary member and the stationary member, with a through hole formed at a predetermined position in the stationary member to be parallel to the central axis and defining fluid circulating space for coupling upper and lower portions of the hydrodynamic space with each other, a cover which is fastened to an upper surface of the stationary member and defines a fluid reservoir between the rotary member and the cover, the fluid reservoir coupled to the hydrodynamic space and having a tapered cross-section, and a support member which is fastened to a lower end of the stationary member and supports a lower portion of the rotary member. In this case, the rotary member is supported in a non-contact manner by hydrodynamic action of fluid in the hydrodynamic space, and the upper and lower portions of the hydrodynamic space are coupled to each other via the fluid circulating space, and annular fluid storage space is further formed between the cover and the upper surface of the stationary member, the fluid storage space being coupled at a predetermined position to a lower portion of the tapered fluid reservoir, so that the fluid storage space serves as an additional fluid reservoir.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional sealing structure for hydrodynamic bearings;

FIG. 2 is a sectional view showing another conventional sealing structure for hydrodynamic bearings;

FIG. 3 is a sectional view showing a hydrodynamic bearing, according to the first embodiment of the present invention;

FIG. 4 is an exploded perspective view showing the hydrodynamic bearing of FIG. 3;

FIGS. 5A and 5B are a sectional view of a fluid reservoir and a plan view of fluid storage space, when a maximum amount of fluid is supplied to the hydrodynamic bearing;

FIGS. 6A to 6C are a sectional view of the fluid reservoir and a plan view of the fluid storage space, when some of the fluid is evaporated from the hydrodynamic bearing;

FIG. 7 is a sectional view showing a hydrodynamic bearing, according to the second embodiment of the present invention;

FIG. 8 is an exploded perspective view showing the hydrodynamic bearing of FIG. 7;

FIG. 9 is a sectional view showing a hydrodynamic bearing, according to the third embodiment of the present invention; and

FIG. 10 is an exploded perspective view showing the hydrodynamic bearing of FIG. 9.

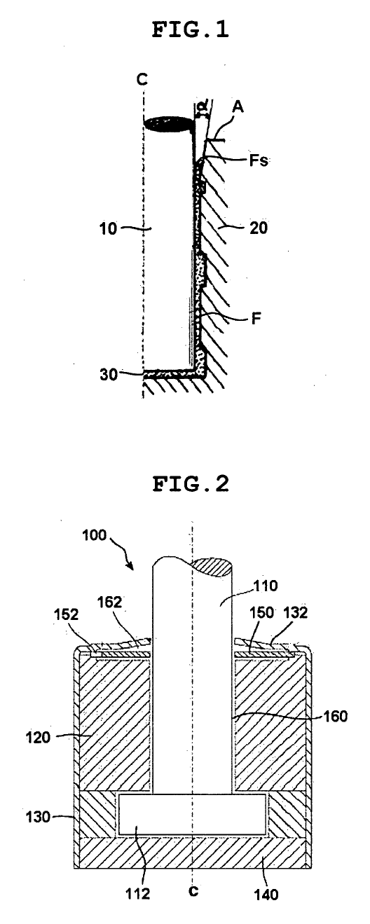

### DESCRIPTION OF THE PREFERRED EMBODIMENTS

Hereinafter, the preferred embodiments of the present invention will be described with reference to the accompanying drawings.

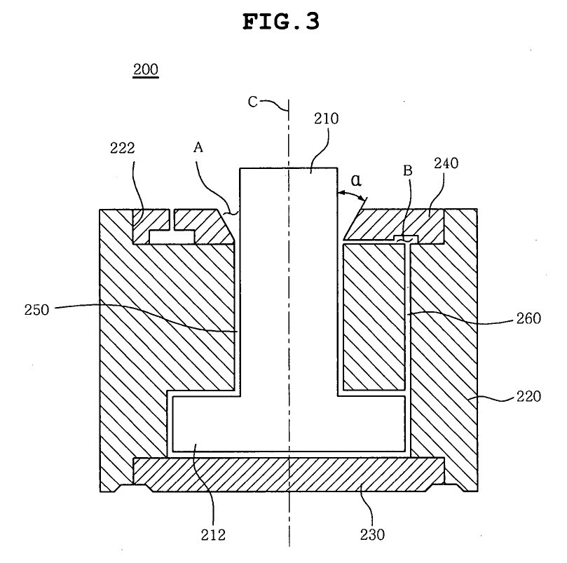

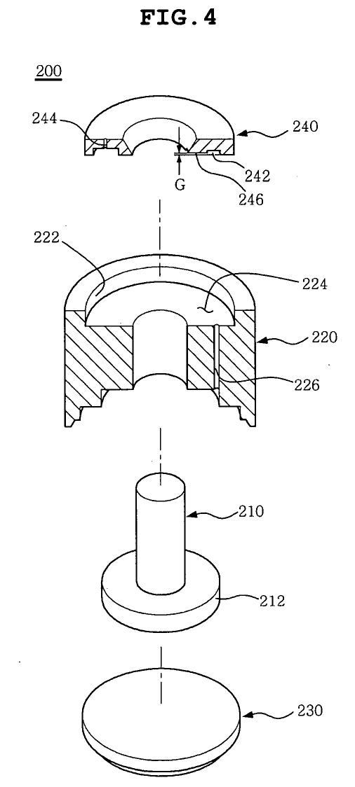

FIG. 3 is a sectional view showing a hydrodynamic bearing 200, according to the first embodiment of the present invention, and FIG. 4 is an exploded perspective view showing the hydrodynamic bearing of FIG. 3. Referring to FIGS. 3 and 4, the construction of the hydrodynamic bearing 200 according to the first embodiment of the invention will be described.

The hydrodynamic bearing 200 according to the invention includes a rotary member 210 which rotates about a central axis C, with a flange 212 protruding from the lower portion of the rotary member 210. An annular stationary member 220 surrounds the side surface of the rotary member 210. A support member 230 supports the lower portion of the rotary member 210. Further, a cover 240 covers the upper surface of the stationary member 220. A very narrow hydrodynamic space 250 is formed along the side surface and the lower portion of the rotary member 210. The rotary member 210 can be supported in a non-contact manner by the hydrodynamic action of fluid (e.g. lubricant) in the hydrodynamic space. Further, a through hole 226 is formed in the stationary member 220 to be parallel to the central axis. The through hole 226 may serve as fluid circulating space 260 which couples the upper and lower portions of the hydrodynamic space with each other.

The present invention is characterized in that a fluid reservoir A having a cross-section that is tapered at a predetermined angle α is defined between the cover 240 and the rotary member 210 to be coupled to the upper portion of the hydrodynamic space 250, and annular fluid storage space B is further defined between the upper surface 224 of the stationary member 220 and the lower portion of the cover 240. The cover 240 is fastened to the upper surface 224 of the stationary member 220. Preferably, a step 222 is formed in the upper portion of the stationary member 220, so that the cover 240 can be placed in the step 222.

Further, the fluid storage space B is coupled to the tapered lower portion of the fluid reservoir A at one position, for example, at a position corresponding to the fluid circulating space 260, so that the fluid storage space B serves as an additional fluid reservoir.

Generally, the fluid reservoir must be formed to seal and store fluid using the space having the tapered cross-section, in addition to supplying the fluid into the hydrodynamic space around the rotary member 210.

The annular fluid storage space B of the invention is formed by an annular groove 242 which is formed in the lower portion of the cover 240. As shown in FIG. 3, a side of the fluid storage space B opposite the tapered fluid reservoir A communicates with the exterior through a hole 244 which is formed through the cover 240. Moreover, the fluid storage space B is formed such that a portion of the fluid storage space B coupled to the fluid reservoir A has the smallest cross-section, and a portion of the fluid storage space B coupled to the hole 244 has the largest cross-section, thus the overall cross-section is tapered. The tapered cross-section allows the fluid storage space B to serve as an additional fluid reservoir.

Meanwhile, the sealing structure (fluid reservoir and fluid storage space) of the present invention may be formed as follows.

For example, the tapered fluid reservoir A is realized by the cover 240, which is inclined at a surface thereof at an angle of about 25°. The minimum width of the tapered fluid reservoir A is about 0.08 mm, and the maximum width of the tapered fluid reservoir A is about 0.13 mm. Here, the rotary member 210 may be formed to have a diameter of 3 mm. Further, the fluid storage space B may be formed such that the portion coupled to the fluid reservoir A has a minimum cross-section, for example, a cross-section of 0.3 mm×0.75 mm, and the portion coupled to the hole 244 has a maximum cross-section, for example, a cross-section of 0.4 mm×1.0 mm. Each of the fluid reservoir A and the fluid storage space B maintains the tapered shape.

These numerical values are given as one example for achieving the sealing structure according to the present invention. It is apparent that the numerical values may be variously changed and modified without departing from the scope and spirit of the invention, as long as the surface pressure F_{B}_{_{—}}max of the fluid storage space B is equal to the surface pressure F_{A}_{_{—}}max of the fluid reservoir A, so that it serves as an additional fluid reservoir.

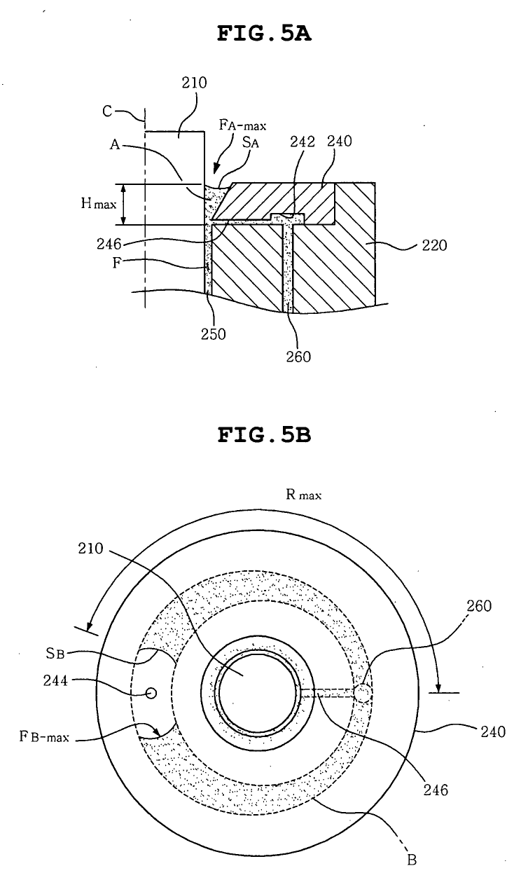

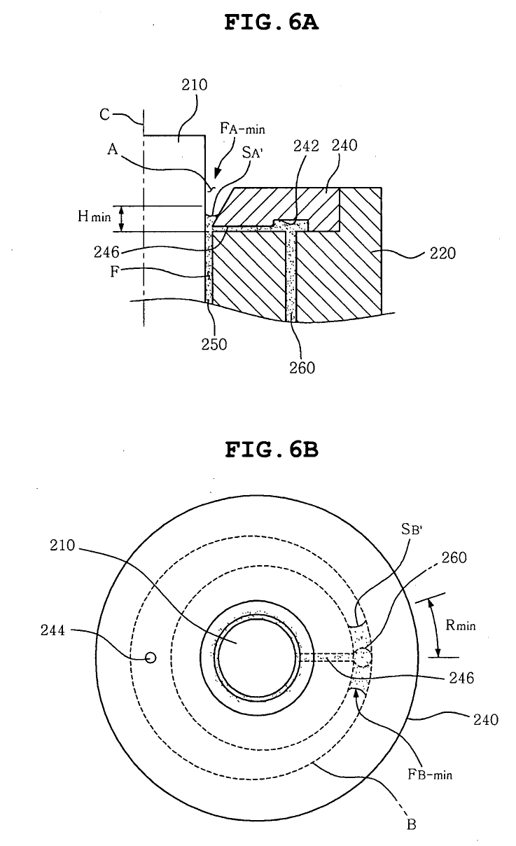

FIGS. 5A and 5B illustrate the hydrodynamic bearing when fluid is maximally supplied, and FIGS. 6A and 6B illustrate the hydrodynamic bearing after it has been used for a predetermined period of time.

FIGS. 5A and 6A are sectional views showing the fluid reservoir A in detail, and

FIGS. 5B and 6B are plan views showing the fluid storage space B in detail.

As shown in FIGS. 5A and 5B, when fluid F is supplied to the hydrodynamic bearing according to the invention, a surface S_{A} of the fluid F rises up to the maximum height Hmax of the fluid reservoir A. Simultaneously, the surface S_{B} of the fluid F moves to the maximum range Rmax of the fluid storage space B. At this time, pressure F_{A}_{_{—}}max, acting on the fluid surface S_{A} of the fluid reservoir A, becomes equal to pressure F_{B}_{_{—}}max, acting on the fluid surface S_{B} of the fluid storage space B. That is, pressure (i.e. surface tension) acting on the portion of the fluid surface S_{A} of the fluid reservoir A contacting the air becomes equal to pressure (i.e. surface tension) acting on the portion of the fluid surface S_{B} of the fluid storage space B contacting the air, thus sealing the fluid.

Afterwards, when the hydrodynamic bearing is used or a long time has passed, the fluid in the hydrodynamic bearing may be consumed by evaporation or friction. Thereby, the amount of fluid in the hydrodynamic bearing is reduced, so that the fluid surface moves. For example, as shown in FIGS. 6A and 6B, the surface S_{A}′ of the fluid F in the fluid reservoir A moves down to the minimum height Hmin. Simultaneously, the surface S_{B}′ of the fluid F in the fluid storage space B moves to the minimum range Rmin. In this case, the pressure F_{A}_{_{—}}min acting on the fluid surface S_{A}′ of the fluid reservoir A becomes equal to the pressure F_{B}_{_{—}}min acting on the fluid surface S_{B}′ of the fluid storage space B.

As such, since the fluid reservoir A and the fluid storage space B are coupled at one position via a coupling channel 246, it is apparent that the pressure acting on both sides S_{A} and S_{B} of the fluid F are equal to each other. According to the height of the fluid surface in the fluid reservoir A and the moving distance of the fluid surface in the fluid storage space, the sealing of the fluid is stably achieved. In addition to the existing fluid reservoir A, the fluid storage space of the invention serves as an additional fluid reservoir, thus providing a fluid reservoir having a sufficient volume.

Meanwhile, in the above-mentioned construction, the fluid storage space is defined by the groove 242 which is formed in the lower portion of the cover 240. However, the fluid storage space is not limited to this construction. That is, after a groove is formed in the upper surface 224 of the stationary member 220, which engages with the cover 240, the fluid storage space may be formed using the groove. In this case, it is preferable that the coupling channel coupling the lower portion of the fluid reservoir A with the fluid storage space B be formed in the upper surface of the stationary member.

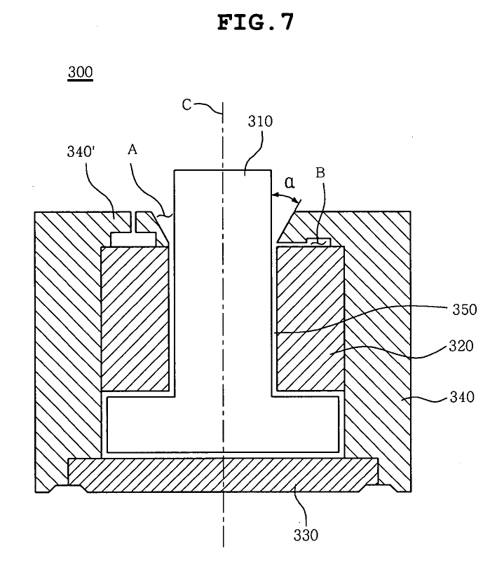

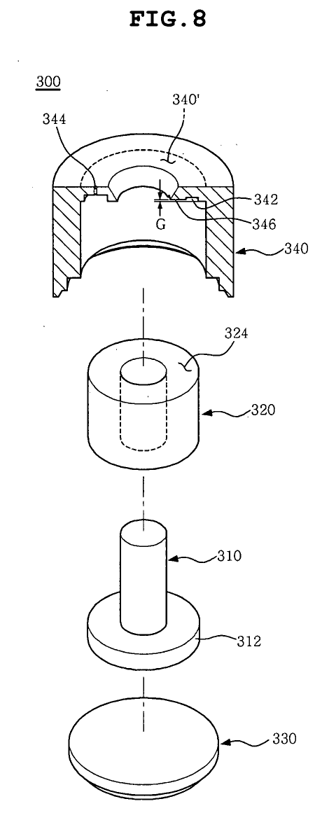

The construction of a hydrodynamic bearing 300 according to the second embodiment of the present invention will be described below with reference to FIGS. 7 and 8.

The hydrodynamic bearing 300 of the second embodiment is different from the hydrodynamic bearing 200 (see, FIG. 3) of the first embodiment in that it has a housing 340 surrounding a stationary member 320, and part of the housing 340 protrudes inwards to form a cover 340′.

The hydrodynamic bearing 300 according to this embodiment includes a rotary member 310 which rotates about a central axis C and is provided with a flange 312. The annular stationary member 320 surrounds the side surface of the rotary member 310. A support member 330 supports the lower portion of the rotary member 310. The annular housing 340 surrounds the stationary member 320. Further, the cover 340′ protrudes inwards from the housing 340, and covers the upper surface of the stationary member 320.

The present invention is characterized in that a fluid reservoir A having a cross-section that is tapered at a predetermined angle α is defined between the cover 340′ and the rotary member 310 to communicate with the upper portion of the hydrodynamic space 350, and annular fluid storage space B is further defined between the upper surface 324 of the stationary member 320 and the lower portion of the cover 340′.

Further, the fluid storage space B is coupled to the tapered lower portion of the fluid reservoir A at one position thereof, so that the fluid storage space B serves as an additional fluid reservoir.

The annular fluid storage space B of the invention is defined by an annular groove 342 which is formed in the lower portion of the cover 340′. As shown in FIG. 7, the side of the fluid storage space B that is opposite the tapered fluid reservoir A communicates with the exterior through a hole 344 which is formed through the cover 340′. Moreover, the fluid storage space B is formed such that a portion of the fluid storage space B coupled to the fluid reservoir A has the smallest cross-section, and a portion of the fluid storage space B coupled to the hole 344 has the largest cross-section, thus the overall cross-section is substantially tapered.

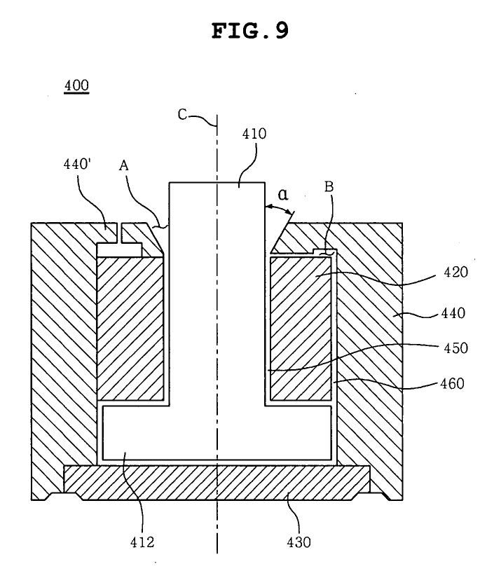

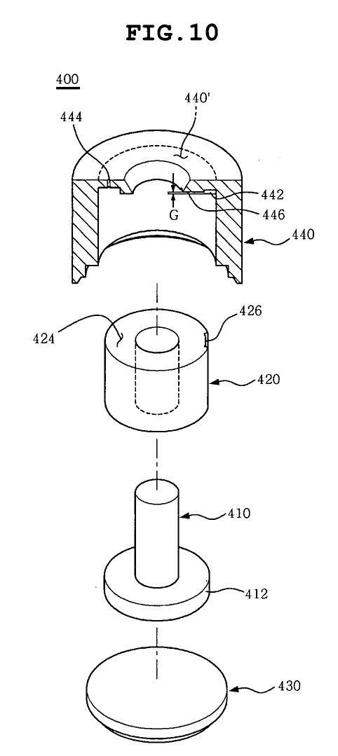

The construction of a hydrodynamic bearing 400 according to the third embodiment of the present invention will be described below with reference to FIGS. 9 and 10.

The hydrodynamic bearing 400 of the third embodiment is different from the hydrodynamic bearing 200 (see, FIG. 3) of the first embodiment in that it has a housing 440 surrounding a stationary member 420, part of the housing 440 protrudes inwards to form a cover 440′, and fluid circulating space 460 is further defined between the stationary member 420 and the housing 440.

The hydrodynamic bearing 400 according to this embodiment includes a rotary member 410 which rotates about a central axis C and is provided with a flange 412. The annular stationary member 420 surrounds the side surface of the rotary member 410. A support member 430 supports the lower portion of the rotary member 410. The annular housing 440 surrounds the stationary member 420. Further, the cover 440′ protrudes inwards from the housing 440, thus covering the upper surface of the stationary member 420.

The present invention is characterized in that a fluid reservoir A having a cross-section tapered at a predetermined angle α is defined between the cover 440′ and the rotary member 410 to communicate with the upper portion of the hydrodynamic space 450, and in that an annular fluid storage space B is further defined between the upper surface 424 of the stationary member 420 and the lower portion of the cover 440′.

The annular fluid storage space B of the invention is defined by an annular groove 442 which is formed in the lower portion of the cover 440′. As shown in FIG. 11, the side of the fluid storage space B opposite the tapered fluid reservoir A communicates with the exterior through a hole 444 which is formed through the cover 440′. Moreover, the fluid storage space B is formed such that the portion of the fluid storage space B that is coupled to the fluid reservoir A has the smallest cross-section, and the portion of the fluid storage space B that is coupled to the hole 444 has the largest cross-section, thus the overall cross-section is substantially tapered.

Moreover, according to this embodiment, the hydrodynamic bearing 400 includes fluid circulating space 460 which couples the upper and lower portions of hydrodynamic space 450 to each other, thus keeping the pressure of the fluid in the hydrodynamic space constant. The fluid circulating space 460 may be formed by a groove 426 which is formed in the side surface of the stationary member 420 to be coupled to the fluid storage space B at a side adjacent to the position where the fluid storage space B is coupled to the fluid reservoir A.

As described above, the hydrodynamic bearing according to the invention provides the annular fluid storage space B coupled to the lower portion of the tapered fluid reservoir A, and provides the tapered cross-section to the fluid storage space B, so that the fluid storage space can serve as an additional fluid reservoir.

Further, the annular fluid storage space B has a volume larger than that of the existing fluid reservoir A. Thus, even when the hydrodynamic bearing has been used for a lengthy period of time or fluid is evaporated, and thus the amount of fluid is reduced, a sufficient amount of fluid can be stably supplied to the hydrodynamic space. Since the fluid storage space also has a tapered cross-section, the fluid storage space can realize the sealing of the fluid in cooperation with the fluid reservoir, thus serving as an additional fluid reservoir.

As described above, the present invention provides a hydrodynamic bearing, which has an annular fluid storage space coupled to the lower portion of a fluid reservoir, in addition to the existing fluid reservoir formed in the upper portion of a hydrodynamic space. In particular, the fluid storage space has a tapered cross-section which is increased in the direction from the end where the fluid storage space is coupled to the fluid reservoir to the opposite end (the portion where a through hole is formed), thus serving as an additional fluid reservoir for sealing fluid and supplying the fluid to the hydrodynamic space. Further, unlike the prior art, where the surface of the fluid is controlled using only the existing fluid reservoir, having a relatively narrow area, the surface of the fluid can be controlled using both a wider fluid storage space and the existing fluid reservoir, thus affording convenience when the hydrodynamic bearing is used.

What is claimed is:

1. A hydrodynamic bearing, comprising:
a rotary member rotating about a central axis;
an annular stationary member fastened to the rotary member, with a very narrow gap provided in a radial direction of the rotary member, thus defining hydrodynamic space between the rotary member and the stationary member;
a cover fastened to an upper surface of the stationary member, and defining a fluid reservoir between the rotary member and the cover, the fluid reservoir coupled to the hydrodynamic space and having a tapered cross-section; and
a support member fastened to a lower end of the stationary member, and supporting a lower portion of the rotary member, wherein
the rotary member is supported in a non-contact manner by hydrodynamic action of fluid in the hydrodynamic space, and
an annular fluid storage space is further formed between the cover and the upper surface of the stationary member, the fluid storage space being coupled at a predetermined position to a lower portion of the tapered fluid reservoir, so that the fluid storage space serves as an additional fluid reservoir.

2. The hydrodynamic bearing as set forth in claim 1, wherein a portion of the fluid storage space opposite a portion where the fluid storage space is coupled to the fluid reservoir communicates with an exterior through a hole which is formed through the cover, and pressure acting on a fluid surface in the fluid storage space is equal to pressure acting on a fluid surface in the fluid reservoir.

3. The hydrodynamic bearing as set forth in claim 2, wherein the fluid surface formed in the fluid reservoir is an annular fluid surface formed in the radial direction of the rotary member.

4. The hydrodynamic bearing as set forth in claim 2, wherein the fluid storage space is formed to have a cross-section which gradually increases in a direction from a portion where the fluid storage space is coupled to the fluid reservoir to a portion of the fluid storage space adjacent to the hole passing through the cover.

5. The hydrodynamic bearing as set forth in claim 1, wherein an annular groove is formed in a lower portion of the cover corresponding to the upper surface of the stationary member, thus defining the fluid storage space.

6. The hydrodynamic bearing as set forth in claim 5, wherein a coupling channel is formed in the cover to extend from a position in the annular groove coupled to the fluid reservoir, the fluid storage space being coupled to the fluid reservoir via the coupling channel.

7. The hydrodynamic bearing as set forth in claim 1, wherein the rotary member has on a lower portion thereof a flange protruding in the radial direction of the rotary member.

8. The hydrodynamic bearing as set forth in claim 7, further comprising:
an annular housing surrounding the stationary member,
wherein the cover comprises an annular protruding part which is provided on an upper portion of the housing, formed to be higher than the upper surface of the stationary member, and protrudes toward the rotary member.

9. The hydrodynamic bearing as set forth in claim 8, wherein a very narrow gap is provided between the lower portion of the stationary member and the flange, thus forming additional hydrodynamic space between the stationary member and the flange, and the support member is fastened to a lower end of the housing.

10. The hydrodynamic bearing as set forth in claim 1, wherein the stationary member further comprises a through hole formed in a direction parallel to the central axis, the through hole serving as fluid circulating space for coupling upper and lower portions of the hydrodynamic space with each other.

11. A hydrodynamic bearing, comprising:
a rotary member rotating about a central axis;
an annular stationary member fastened to the rotary member, with a very narrow gap provided in a radial direction of the rotary member, thus defining a hydrodynamic space between the rotary member and the stationary member, with a through hole formed at a predetermined position in the stationary member to be parallel to the central axis and defining fluid circulating space for coupling upper and lower portions of the hydrodynamic space with each other;
a cover fastened to an upper surface of the stationary member, and defining a fluid reservoir between the rotary member and the cover, the fluid reservoir coupled to the hydrodynamic space and having a tapered cross-section; and
a support member fastened to a lower end of the stationary member, and supporting a lower portion of the rotary member, wherein
the rotary member is supported in a non-contact manner by hydrodynamic action of fluid in the hydrodynamic space, and the upper and lower portions of the hydrodynamic space are coupled to each other via the fluid circulating space, and
annular fluid storage space is further formed between the cover and the upper surface of the stationary member, the fluid storage space being coupled at a predetermined position to a lower portion of the tapered fluid reservoir, so that the fluid storage space serves as an additional fluid reservoir.

12. The hydrodynamic bearing as set forth in claim 11, wherein a portion of the fluid storage space opposite a portion where the fluid storage space is coupled to the fluid reservoir communicates with an exterior through a hole which is formed through the cover, and pressure acting on a fluid surface in the fluid storage space is equal to pressure acting on a fluid surface in the fluid reservoir.

13. The hydrodynamic bearing as set forth in claim 12, wherein the fluid surface formed in the fluid reservoir is an annular fluid surface formed in the radial direction of the rotary member.

14. The hydrodynamic bearing as set forth in claim 12, wherein the fluid storage space is formed to have a cross-section which gradually increases in a direction from a portion where the fluid storage space is coupled to the fluid reservoir to a portion of the fluid storage space adjacent to the hole passing through the cover.

15. The hydrodynamic bearing as set forth in claim 11, wherein an annular groove is formed in a lower portion of the cover corresponding to the upper surface of the stationary member, thus defining the fluid storage space.

16. The hydrodynamic bearing as set forth in claim 15, wherein a coupling channel is formed in the cover to extend from a position in the annular groove coupled to the fluid reservoir, the fluid storage space being coupled to the fluid reservoir via the coupling channel.

17. The hydrodynamic bearing as set forth in claim 11, wherein the rotary member has on a lower portion thereof a flange protruding in the radial direction of the rotary member.

18. The hydrodynamic bearing as set forth in claim 17, further comprising:
an annular housing surrounding the stationary member,
wherein the cover comprises an annular protruding part which is provided on an upper portion of the housing, formed to be higher than the upper surface of the stationary member, and protrudes toward the rotary member.

19. The hydrodynamic bearing as set forth in claim 18, wherein a very narrow gap is provided between a lower portion of the stationary member and the flange, thus forming an additional hydrodynamic space between the stationary member and the flange, and the support member is fastened to a lower end of the housing.
